(19) United States
(12) Patent Application Publication
(10) Pub. No.: US 2012/0154554 A1
(43) Pub. Date: Jun. 21, 2012

(54) VIDEO SIGNAL PROCESSING APPARATUS, PROCESSING METHOD, AND VIDEO DISPLAY APPARATUS

(75) Inventors: Toshimasa OOTUKI, Saitama-Shi (JP); Takeshi INAGAKI, Yokohama-Shi (JP); Takeshi SHIMODA, Sagamihara-Shi (JP); Yoshiyuki KATO, Tokyo (JP); Masahiro YAMADA, Tokyo (JP)

(73) Assignee: KABUSHIKI KAISHA TOSHIBA, Tokyo (JP)

(21) Appl. No.: 13/198,438

(22) Filed: Aug. 4, 2011

(30) Foreign Application Priority Data
Dec. 21, 2010 (JP) 2010-284701

(51) Int. Cl. H04N 13/04

(52) U.S. Cl. 348/51; 348/E13.075

(57) ABSTRACT

A video signal processing apparatus according to an embodiment includes: a sharpening processing circuit configured to perform processing of sharpening a multiple parallax video concerning an input video signal; a viewing zone boundary improvement processing circuit configured to perform processing of improving a viewing zone boundary of the multiple parallax video subjected to the sharpening processing; and a viewing zone expansion processing circuit configured to perform processing of expanding a viewing zone on the multiple parallax video subjected to the viewing zone boundary improvement processing.

### CROSS-REFERENCE TO RELATED APPLICATION

This application is based upon and claims the benefit of priority from prior Japanese Patent Application No. 2010-284701 filed on Dec. 21, 2010 in Japan, the entire contents of which are incorporated herein by reference.

### FIELD

Embodiments described herein relate generally to a video signal processing apparatus, a processing method, and a video display apparatus.

### BACKGROUND

In processing of expanding a viewing zone when generating a stereoscopic video signal from a multiple parallax signal, rearrangement for expanding the viewing zone is conducted and conversion to tile images is conducted. Thereafter, in order to improve degradation in the viewing zone boundary, the tile images are stored in an image memory and viewing zone boundary improvement processing is conducted. Therefore, an exterior memory becomes necessary, resulting in a problem of an increased manufacturing cost.

### BRIEF DESCRIPTION OF THE DRAWINGS

FIG. 1 is a block diagram showing a video display apparatus according to a first embodiment;

FIG. 2 is a block diagram showing a specific example of a sharpening processing circuit;

FIG. 3 is a circuit diagram showing a specific example of a filter circuit in the sharpening processing circuit;

FIG. 4 is a block diagram showing a specific example of a viewing zone boundary improvement processing circuit;

FIG. 5 is a block diagram showing a specific example of a viewing zone expansion processing circuit;

FIG. 6 is a diagram for explaining a multiple parallax video obtained before viewing zone expansion processing is conducted;

FIG. 7 is a diagram for explaining a multiple parallax video obtained after viewing zone expansion processing is conducted;

FIG. 8 is a block diagram showing a video display apparatus according to a second embodiment;

FIG. 9 is a block diagram showing a video display apparatus according to a third embodiment;

FIG. 10 is a block diagram showing a video display apparatus according to a fourth embodiment; and

FIG. 11 is a block diagram showing a video display apparatus according to a fifth embodiment.

### DETAILED DESCRIPTION

Hereafter, embodiments according to the invention will be described more specifically with reference to the drawings.

A video display apparatus according to an embodiment includes: a sharpening processing circuit configured to perform processing of sharpening a multiple parallax video concerning an input video signal; a viewing zone boundary improvement processing circuit configured to perform processing of improving a viewing zone boundary of the multiple parallax video subjected to the sharpening processing; and a viewing zone expansion processing circuit configured to perform processing of expanding a viewing zone on the multiple parallax video subjected to the viewing zone boundary improvement processing.

### First Embodiment

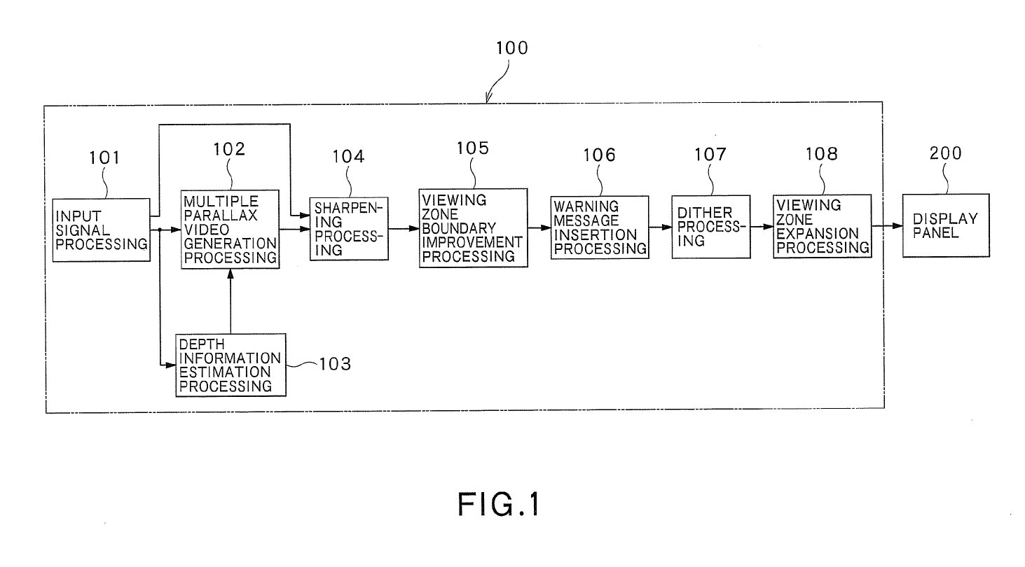

A video display apparatus according to a first embodiment is shown in FIG. 1. The video display apparatus according to the first embodiment includes a video signal processing unit 100 and a display panel 200. The display panel 200 includes a display unit (not illustrated) having pixels arranged in a matrix form. The display panel 200 is a plane display panel such as, for example, a liquid crystal display panel or a plasma display panel. In addition, the display panel 200 is disposed to oppose to the display unit. The display panel 200 also includes an optical plate (not illustrated) having a plurality of exit pupils to control light rays illuminated from the pixels. In general, the optical plate is called parallax barrier or parallax barrier as well. Each exit pupil of the optical plate controls light rays to make different images visible in accordance with the angle even in the same position. Specifically, in a case of giving only lateral disparity (horizontal disparity), a slit sheet having a plurality of slits or a lenticular sheet (cylindrical lens array) is used. In a case where up-down parity (vertical disparity) is also included, a pinhole array or a fly eye lens array is used. In other words, a slit of the slit sheet, a cylindrical lens of the cylindrical lens array, a pinhole of the pinhole array or a fly eye lens of the fly eye lens array becomes each exit pupil. In the present embodiment and second to fifth embodiments which will be described later, the display panel 200 includes an optical plate having a plurality of exit pupils. However, a display panel in which a parallax barrier is generated electronically by using a transmission type liquid crystal display device or the like and the shape or position of a barrier pattern is subject to electronically variable control may be used. Any display panel may be used as long as a video for three-dimensional video display can be displayed.

The video signal processing unit 100 includes an input signal processing circuit 101, a multiple parallax video generation circuit 102, a depth information estimation circuit 103, a sharpening processing circuit 104, a viewing zone boundary improvement processing circuit 105, a warning message insertion processing circuit 106, a dither processing circuit 107, and a viewing zone expansion processing circuit 108.

A video signal is input to the input signal processing circuit 101 via a broadcast or a network. This video signal is a coded two-dimensional video signal or a coded multiple parallax video signal. If the input video signal is the coded two-dimensional video signal, then the input signal processing circuit 101 decodes the coded two-dimensional video signal and sends the decoded two-dimensional video signal to the multiple parallax video generation circuit 102 and the depth information estimation circuit 103. If the input video signal is the coded multiple parallax video signal, then the input signal processing circuit 101 decodes the coded multiple parallax video signal and sends the decoded multiple parallax video signal (multiple parallax video) to the sharpening processing circuit 104.

The depth information estimation circuit 103 estimates depth information of a two-dimensional video which depends upon the two-dimensional video signal sent from the input signal processing circuit 101, by using a known method. For example, the depth information estimation circuit 103 estimates the depth information of the two-dimensional video by using motion information or the like between frames.

The multiple parallax video generation circuit 102 generates a plurality of parallax videos (a multiple parallax video) used in three-dimensional video display, from a two-dimensional video signal by using the depth information obtained by the depth information estimation circuit 103. The multiple parallax video has pixels which correspond to respective exit pupils in the display panel 200. Each pixel includes a plurality of parallax videos.

In general, the processing of generating a multiple parallax video is designed to provide the multiple parallax video with crosstalk to cause the multiple parallax video to change continuously and thereby prevent a three-dimensional video from looking unnatural even if the viewpoint of the viewer moves. Even if the viewer views the video in the viewing zone, therefore, the video becomes multiplex and the sharpness is lost. In order to prevent this, in the present embodiment, the multiple parallax video sent via the input signal processing circuit 101 or the multiple parallax video generated by the multiple parallax video generation circuit 102 undergoes sharpening processing in the sharpening processing circuit 104.

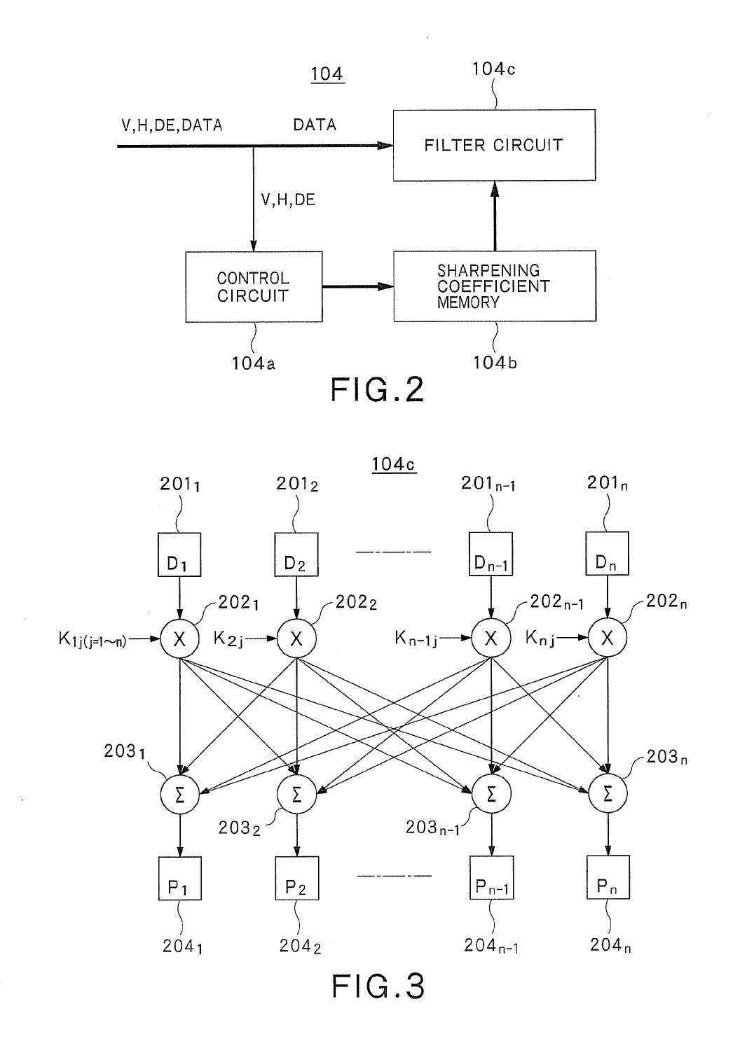

The sharpening processing circuit 104 conducts weighting on a plurality of parallax videos included in respective pixels of the input multiple parallax video by using sharpening coefficients in accordance with light ray characteristics of the optical plate in the display panel 200 (for example, light ray degradation characteristics of a cylindrical lens), that is, a luminance profile of the display panel 200, and generates a sharpened multiple parallax video. By the way, the light ray degradation characteristics of the lens (the luminance profile of the display panel) depends uniquely on the display panel in use, and the sharpening coefficients are determined in accordance with the luminance profile of the display panel 200. The sharpening processing will now be described in more detail with reference to FIGS. 2 to 4.

A specific example of the sharpening processing circuit 104 is shown in FIG. 2. The sharpening processing circuit 104 in this specific example includes a control circuit 104a, a sharpening coefficient memory 104b, and a filter circuit (arithmetic operation circuit) 104c. The sharpening coefficients to be used for weighting of the sharpening processing are stored in the sharpening coefficient memory 104b. For example, if a multiple parallax video is formed of nine parallax videos, there are nine sharpening coefficients concerning nine parallax videos which are input to the sharpening processing circuit 104, respectively with respect to nine sharpened parallax videos which are output from the sharpening processing circuit 104. In other words, eighty-one (=9×9) sharpening coefficients Kᵢⱼ (i=1 to 9, j=1 to 9) are stored in the sharpening coefficient memory 104b.

A vertical reference signal V of a multiple parallax video, a horizontal reference signal H of the multiple parallax video, and a data enable signal DE are sent from the input signal processing circuit 101 or the multiple parallax video generation circuit 102 to the control circuit 104a. In addition, video data DATA is sent from the input signal processing circuit 101 or the multiple parallax video generation circuit 102 to the filter circuit 104c. Thereupon, the control circuit 104a detects which parallax video in which pixel corresponds to the current input data DATA, and sends a command signal to the sharpening coefficient memory 104b. Thereupon, sharpening coefficients concerning the parallax video are read out from the sharpening coefficient memory 104b. And the filter circuit 104c conducts arithmetic operation by using the sharpening coefficients which are read out and the data DATA of the parallax video. As a result, the multiple parallax video subjected to the sharpening processing is output from the filter circuit 104c.

The arithmetic operation conducted in the filter circuit 104c will now be described with reference to FIG. 3. FIG. 3 is a block diagram showing a configuration of a specific example of the filter circuit 104c. The filter circuit 104c in this specific example conducts arithmetic operation by taking a pixel as the unit and processes n parallax videos, that is, #1 parallax video to #n parallax video, where n is an integer of at least 2. The filter circuit 104c includes latch circuits 201₁ to 201ₙ, multipliers 202₁ to 202ₙ, adders 203₁ to 203ₙ, and latch circuits 204₁ to 204ₙ.

The latch circuit 201ᵢ (i=1, . . . , n) holds a pixel value Dᵢ of #i parallax image which forms a pixel detected by the control circuit 104a. It is now supposed that j is an arbitrary integer in the range of 1 to n. In a sharpened multiple parallax image which is output from the sharpening processing circuit 104, a pixel value of #j parallax image which forms a pixel corresponding to the pixel detected by the control circuit 104a is denoted by P₃.

The multiplier 202ᵢ (i=1, . . . , n) multiples the pixel value Dᵢ by a sharpening coefficient Kᵢⱼ which is read out from the sharpening coefficient memory 104b, and outputs a product KᵢⱼDᵢ.

The adder 203₃ (j=1, . . . , n) conducts arithmetic operation to obtain the sum of outputs K₁ⱼD₁ to KₙⱼDₙ respectively of the multipliers 202₁ to 202ₙ, and outputs a pixel value Pⱼ of the #j parallax image. In other words, the pixel value Pⱼ is calculated in accordance with the following Expression.

$${P}_{j} = {\sum }_{i = 1}^{n} {K}_{ij} {D}_{i}$$

The latch circuit 204ⱼ (j=1, . . . , n) holds the output Pⱼ of the adder 203₃.

A sharpened multiple parallax image is obtained by conducting such arithmetic operations on each of pixels which form the multiple parallax image.

In the above-described arithmetic operations, weighting is conducted mainly on parallax videos located before and after a parallax video which becomes a multiple image.

Furthermore, the sharpening coefficient Kᵢⱼ (i=1 to n, j=1 to n) satisfies the following conditions.

−2Kᵢⱼ<2

K₁ⱼ+ . . . +Kₙⱼ=1 (j=1, . . . , n)

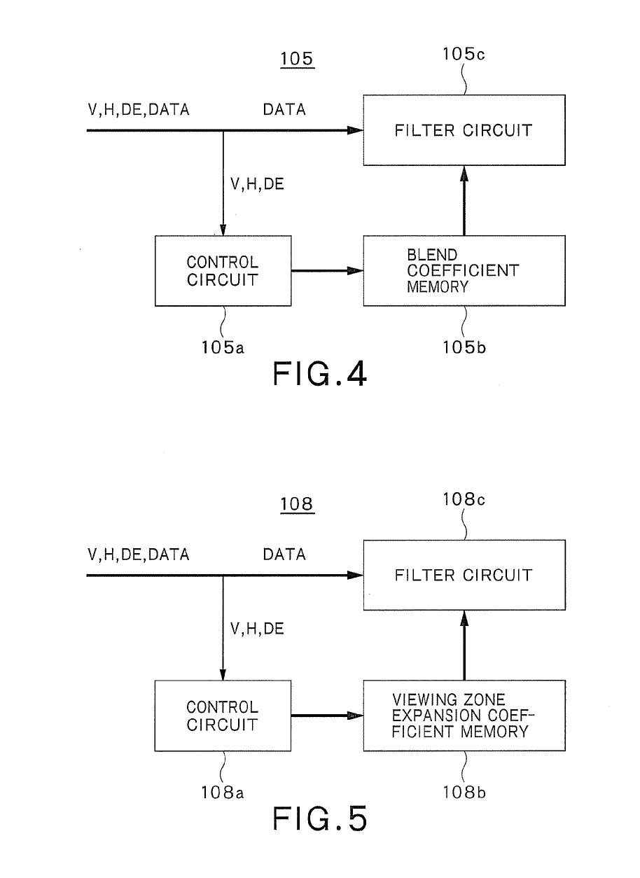

The multiple parallax video sharpened in this way is sent to the viewing zone boundary improvement processing circuit 105. The viewing zone boundary improvement processing circuit 105 conducts blend processing to improve a level difference at the viewing zone boundary generated in the subsequent viewing zone expansion processing circuit 108. In the viewing zone expansion processing, for example, the arrangement order of parallax images is changed every video region as described in JP-A2009-239665 (KOKAI). This is implemented by changing the arrangement of parallax videos every image region in accordance with the angle of the display panel which displays a video viewed by the viewer. Therefore, a changeover between image regions causes a level difference. At this time, a pixel number in which a level difference occurs is known. Therefore, blend processing can be conducted by using a configuration equivalent to that of the sharpening processing conducted in the sharpening processing circuit 104. In other words, the viewing zone boundary can be improved by conducting blend processing on pixels which mainly generate a level difference, by use of a control circuit 105a, a blend coefficient memory 105b which stores blend coefficients, and a filter circuit 105c as shown in FIG. 4.

The multiple parallax video improved in the viewing zone boundary in this way is sent to the warning message insertion processing circuit 106, and a warning message is inserted. This warning message is a message which gives a warning to a viewer who views in a pseudoscopy region. In the generated multiple parallax video, parallax videos are generated for, for example, the right eye and the left eye and arranged in a one lateral column. In a certain viewing place, however, images for the right eye and the left eye are seen conversely and look like a double image. This place is referred to as pseudoscopy region. In particular, the pseudoscopy region is generated at both ends of pixels of the generated multiple parallax image.

Therefore, the warning message insertion processing circuit 106 inserts a warning message into parallax images at both ends of each pixel. As a result, the warning message cannot be recognized in a normal viewing zone region, whereas it becomes possible to recognize the warning message only in the pseudoscopy region. In the multiple parallax video which is input to the warning message insertion processing circuit 106 at this time, parallax images are arranged in order in each pixel. Therefore, the warning message can be inserted easily.

The multiple parallax video with the warning message inserted by the warning message insertion processing circuit 106 is subject to picture quality improvement in the dither processing circuit 107.

The dither processing circuit 107 is a generally known dither processing circuit. The dither processing circuit adds an intentionally appended erroneous signal or data to sample data in order to minimize the quantization error. A known method is used in this dither processing. In the embodiment, the dither processing is conducted not between parallax videos but between pixels in order to obtain effects of the dither processing. In the dither circuit 107 as well, images are input in the order of parallax videos and consequently the dither processing can be conducted between pixels easily.

The multiple parallax image which is output from the dither processing circuit 107 is sent to the viewing zone expansion processing circuit 108. And the viewing zone expansion processing circuit 108 conducts rearrangement of parallax images in order to expand the viewing zone.

The viewing zone expansion processing conducted in the viewing zone expansion processing circuit 108 will now be described with reference to FIGS. 5 to 7. A specific example of the viewing zone expansion processing circuit 108 is shown in FIG. 5. The viewing zone expansion processing circuit 108 in this specific example includes a control circuit 108a, a viewing zone expansion coefficient memory 108b, and a filter circuit 108c.

Viewing zone expansion coefficients to be used for weighting of the viewing zone expansion processing are stored in the viewing zone expansion coefficient memory 108b. For example, if a multiple parallax video is formed of nine parallax videos, there are nine viewing zone expansion coefficients concerning nine parallax videos which are input to the viewing zone expansion processing circuit 108, respectively with respect to nine parallax videos which are expanded in viewing zone and which are output from the viewing zone expansion processing circuit 108. In other words, eighty-one (=9×9) viewing zone expansion coefficients Lᵢⱼ (i=1 to 9, j=1 to 9) are stored in the viewing zone expansion coefficient memory 108b.

The control circuit 108a and the filter circuit 108c have the same configuration and function as those of the control circuit 104a and the filter circuit 104c described with reference to the specific example of the sharpening processing circuit 104 shown in FIG. 2, respectively. Coefficients used for the weighting are not Kᵢⱼ, but the coefficients Lᵢⱼ which are different from Kᵢⱼ are used. The viewing zone is expanded by rearranging the parallax arrangement of each pixel. By the way, the viewing zone expansion coefficients Lᵢⱼ (i=1 to n, j=1 to n) also satisfies the following conditions in the same way as the sharpening coefficients Kᵢⱼ (i=1 to n, j=1 to n).

−2≦Lᵢⱼ<2

L₁ⱼ+ . . . +Lₙⱼ=1 (j=1, . . . , n)

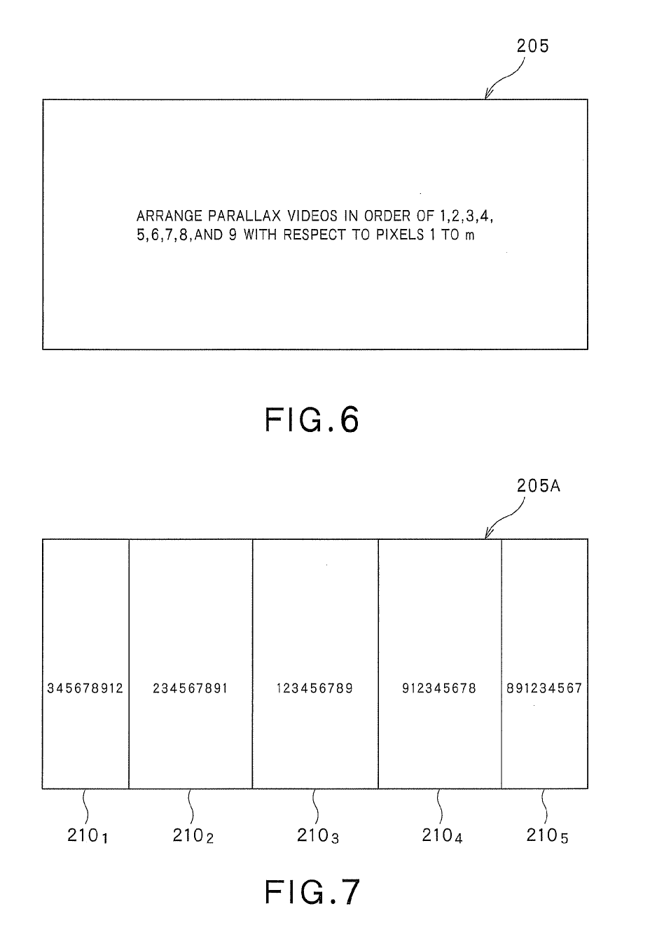

FIG. 6 shows an example of the case where a multiple parallax video 205 obtained before the viewing zone expansion processing is conducted is displayed on the display panel 200. The multiple parallax video 205 is formed of nine parallax videos, that is, #1 parallax video to #9 parallax video. In the multiple parallax video 205, each of pixels respectively corresponding to m exit pupils has a configuration arranged in the order of #1 parallax video, . . . , #9 parallax video as shown in FIG. 6. In FIGS. 6, 1, 2, 3, 4, 5, 6, 7, 8 and 9 indicate numbers of the #1 parallax video, . . . , #9 parallax video, respectively.

The viewing zone expansion processing is processing for expanding the viewing zone in which the viewer can view normally. In particular, the processing expands a region which can be moved to the left or right with respect to the display panel and causes a three-dimensional image to be visible not unnaturally but continuously even if the viewer moves. Parallax videos in each pixel are rearranged by the viewing zone expansion processing. An example of the case where a multiple parallax video 205A obtained after the viewing zone expansion processing conducted by the viewing zone expansion processing circuit 108 is displayed on the display panel 200 is shown in FIG. 7. The multiple parallax video 205A shown in FIG. 7 has five image regions 210₁ to 210₅. In the image region 210₃ located in the center of the multiple parallax video 205A, each pixel has a configuration in which parallax videos are arranged in the order of the #1 parallax video, . . . , #9 parallax video. In the image region 210₂ located on the left side of the image region 210₃, however, each pixel has a configuration in which parallax videos are arranged in the order of the #2 parallax video, #3 parallax video, #4 parallax video, #5 parallax video, #6 parallax video, #7 parallax video, #8 parallax video, #9 parallax video, and #1 parallax video. In the image region 210₁ located at the left end of the multiple parallax video 205A, each pixel has a configuration in which parallax videos are arranged in the order of the #3 parallax video, #4 parallax video, #5 parallax video, #6 parallax video, #7 parallax video, #8 parallax video, #9 parallax video, #1 parallax video, and #2 parallax video. In other words, as the position to the left as one faces from the center image region, the parallax video for the right eye is moved to the central direction.

In the image region 210₄ located on the right side of the image region 210₃, each pixel has a configuration in which parallax videos are arranged in the order of the #9 parallax video, #1 parallax video, #2 parallax video, #3 parallax video, #4 parallax video, #5 parallax video, #6 parallax video, #7 parallax video, and #8 parallax video. In the image region 210₅ located at the right end of the multiple parallax video 205A, each pixel has a configuration in which parallax videos are arranged in the order of the #8 parallax video, #9 parallax video, #1 parallax video, #2 parallax video, #3 parallax video, #4 parallax video, #5 parallax video, #6 parallax video, and #7 parallax video. In other words, as the position to the right as one faces from the center image region, the parallax video for the left eye is moved to the central direction.

The multiple parallax video subjected to the viewing zone expansion processing in the viewing zone expansion processing circuit 108 is sent to the display panel 200, and a three-dimensional video is displayed.

In the first embodiment, the viewing zone boundary improvement processing is conducted and then the viewing zone expansion processing is conducted as described heretofore. The multiple parallax video subjected to parallax video rearrangement in the viewing zone expansion processing is displayed on the display panel. Therefore, it is not necessary to conduct conversion to tile images after the viewing zone expansion processing. As a result, an exterior memory which stores a multiple parallax video to improve the degradation of the viewing zone boundary becomes unnecessary, and an increase of the manufacturing cost can be suppressed.

Furthermore, in the first embodiment, the image sharpening is conducted on the basis of the luminance profile of the display panel, the viewing zone is expanded, and the level difference at a viewing zone boundary is prevented. As a result, a higher picture quality can be implemented.

By the way, the video signal processing units according to the present embodiment and second to fifth embodiments which will be described later are used in the video display apparatus having a display panel. However, those video signal processing units can be used in a video recording/reproducing apparatus having no display panel, such as, a DVD player.

### Second Embodiment

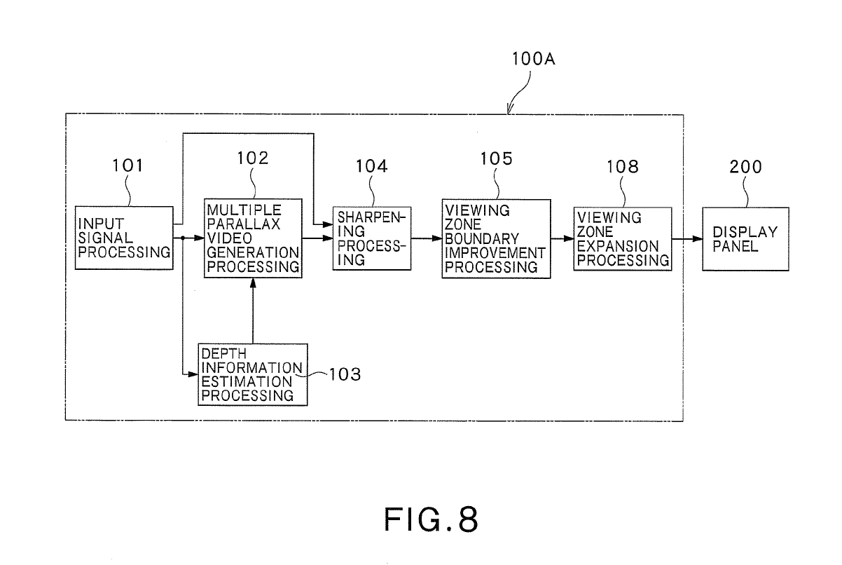

A video display apparatus according to a second embodiment will now be described with reference to FIG. 8. FIG. 8 is a block diagram showing a video display apparatus according to the second embodiment. The video display apparatus according to the second embodiment has a configuration obtained by replacing the video signal processing unit 100 according to the first embodiment shown in FIG. 1 with a video signal processing unit 100A. The video signal processing unit 100A has a configuration obtained by removing the warning message insertion processing circuit 106 and the dither processing circuit 107 from the video signal processing unit 100. Therefore, the viewing zone expansion processing circuit 108 conducts viewing zone expansion processing on the multiple parallax video subjected to the viewing zone boundary improvement processing in the viewing zone boundary improvement processing circuit 105. Furthermore, in the same way as the first embodiment, the display panel 200 displays the multiple parallax video which is output from the viewing zone expansion processing circuit 108.

In the second embodiment as well, the increase of the manufacturing cost can be suppressed and a higher picture quality can be implemented in the same way as the first embodiment.

### Third Embodiment

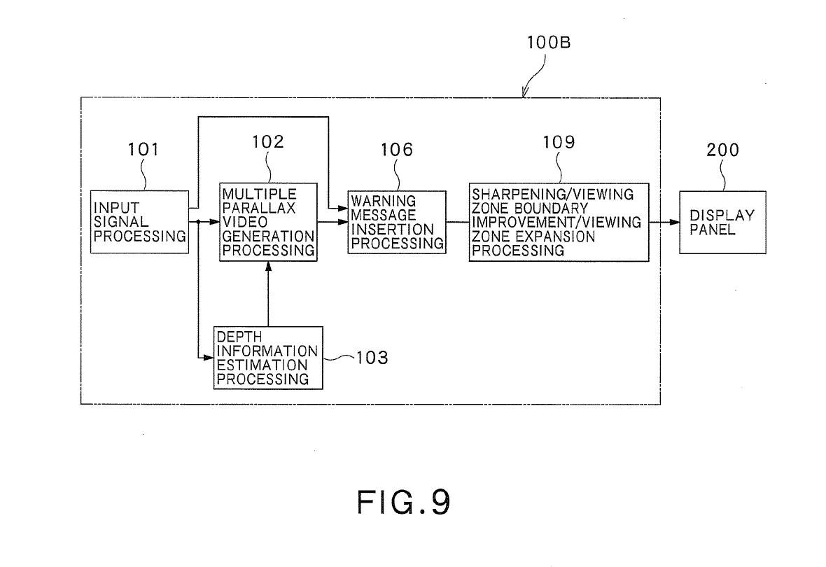

A video display apparatus according to a third embodiment will now be described with reference to FIG. 9. FIG. 9 is a block diagram showing a video display apparatus according to the third embodiment. The video display apparatus according to the third embodiment has a configuration obtained by replacing the video signal processing unit 100 according to the first embodiment shown in FIG. 1 with a video signal processing unit 100B. The video signal processing unit 100B has a configuration obtained by removing the sharpening processing circuit 104, the viewing zone boundary improvement processing circuit 105, and the dither processing circuit 107 and the viewing zone expansion processing circuit 108 from the video signal processing unit 100 and newly providing a sharpening/viewing zone boundary improvement processing/viewing zone expansion processing circuit 109 which conducts sharpening processing, viewing zone boundary improvement processing, and viewing zone expansion processing. In this embodiment, the warning message insertion processing circuit 106 inserts a warning message into a multiple parallax video sent via the input signal processing circuit 101 or a multiple parallax video generated by the multiple parallax video generation circuit 102. The sharpening/viewing zone boundary improvement processing/viewing zone expansion processing circuit 109 conducts sharpening processing, viewing zone boundary improvement processing, and viewing zone expansion processing on the multiple parallax video with the warning message inserted therein.

By the way, the display panel 200 displays the multiple parallax video which is output from the sharpening/viewing zone boundary improvement processing/viewing zone expansion processing circuit 109.

In the third embodiment as well, the increase of the manufacturing cost can be suppressed and a higher picture quality can be implemented in the same way as the first embodiment.

### Fourth Embodiment

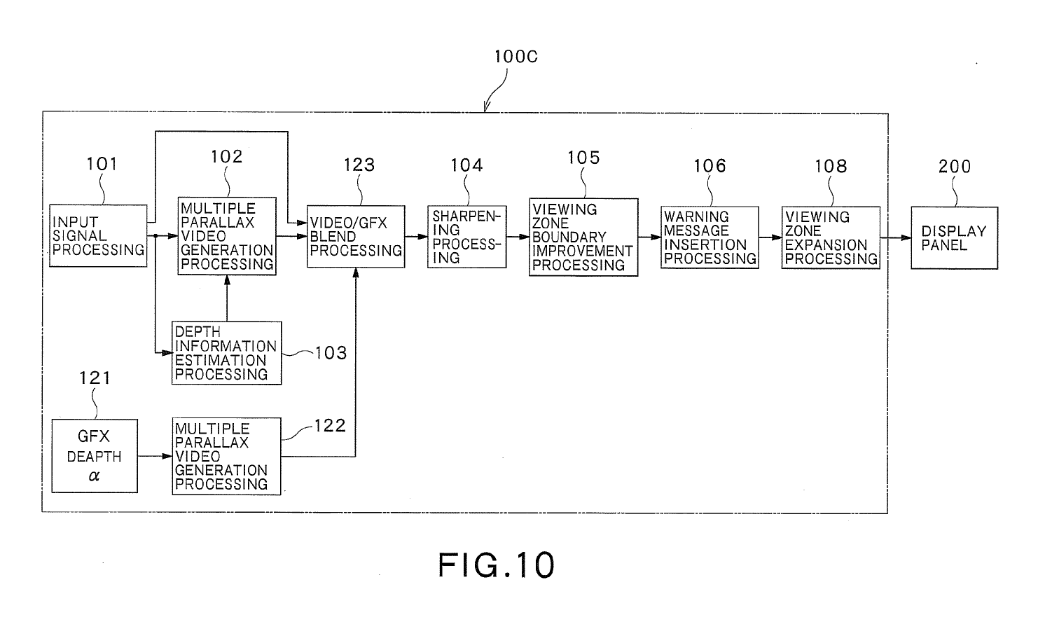

A video display apparatus according to a fourth embodiment will now be described with reference to FIG. 10. FIG. 10 is a block diagram showing a video display apparatus according to the fourth embodiment. The video display apparatus according to the fourth embodiment has a configuration obtained by replacing the video signal processing unit 100 according to the first embodiment shown in FIG. 1 with a video signal processing unit 100C. The video signal processing unit 100C has a configuration obtained by newly providing a graphics generation circuit 121, a multiple parallax video generation circuit 122 for generating multiple parallax video, and a video/GFX blend processing circuit 123 in the video signal processing unit 100. The graphics generation circuit 121 generates graphics on the basis of graphic data (GFX), its depth information Depth, and blend information α. The multiple parallax video generation circuit 122 receives the graphics generated by the graphics generation circuit 121, and generates a multiple parallax video concerning the graphics. The video/GFX blend processing circuit 123 conducts processing of blending a multiple parallax video concerning a video signal with the multiple parallax video concerning the graphics. As well known, the blend processing is conducted by using the blend information α. If the graphics generated by the graphics generation circuit 121 are a multiple parallax video, the graphics are sent directly to the video/GFX blend processing circuit 123 without being passed through the multiple parallax video generation circuit 122.

In the fourth embodiment, the video/GFX blend processing circuit 123 is provided between the multiple parallax video generation circuit 102 and the sharpening processing circuit 104. Therefore, the multiple parallax video sent via the input signal processing circuit 101 or the multiple parallax video generated by the multiple parallax video generation circuit 102 is sent to the video/GFX blend processing circuit 123. A multiple parallax video obtained by the blend processing conducted in the video/GFX blend processing circuit 123 is sent to the sharpening processing circuit 104 and subject to the sharpening processing. Subsequent processing is conducted in the same way as the case described in the first embodiment.

In the fourth embodiment as well, the increase of the manufacturing cost can be suppressed and a higher picture quality can be implemented in the same way as the first embodiment.

### Fifth Embodiment

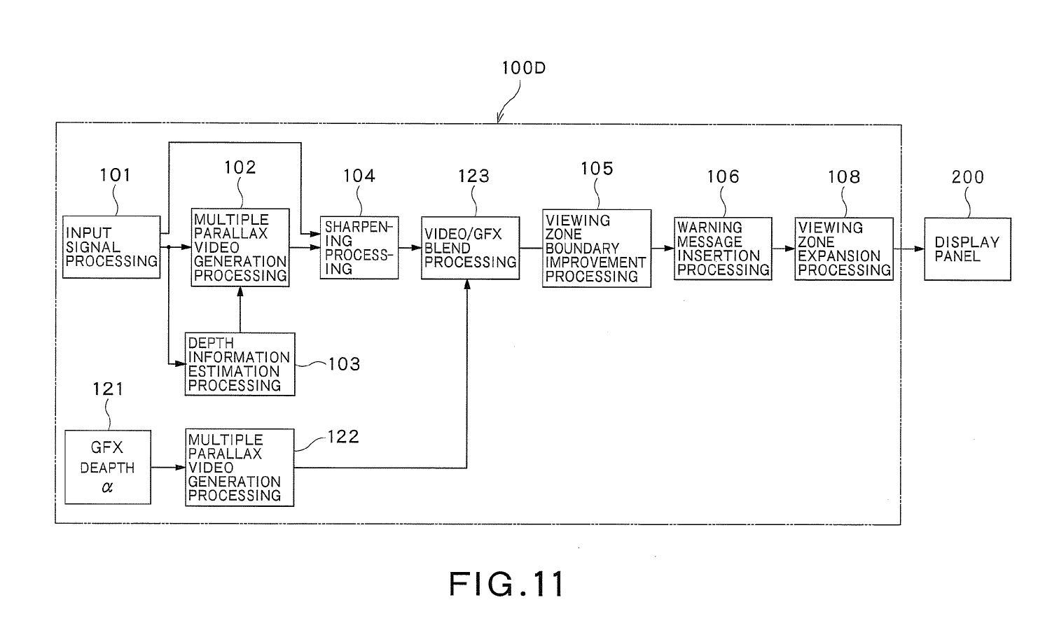

A video display apparatus according to a fifth embodiment will now be described with reference to FIG. 11. FIG. 11 is a block diagram showing a video display apparatus according to the fifth embodiment. The video display apparatus according to the fifth embodiment has a configuration obtained by replacing the video signal processing unit 100C according to the fourth embodiment shown in FIG. 10 with a video signal processing unit 100D. The video signal processing unit 100D, the video/GFX blend processing circuit 123 is provided between the sharpening processing circuit 104 and the viewing zone boundary improvement processing circuit 105 in the video signal processing unit 100C. Therefore, the video/GFX blend processing circuit 123 conducts processing of blending the multiple parallax video subjected to the sharpening processing in the sharpening processing circuit 104 with the multiple parallax video of the graphics, and sends the multiple parallax video subjected to the blend processing to the viewing zone boundary improvement processing circuit 105. Subsequent processing is conducted in the same way as the case described in the first embodiment.

In the fifth embodiment as well, the increase of the manufacturing cost can be suppressed and a higher picture quality can be implemented in the same way as the fourth embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
a video sharpening processor configured to sharpen a first plurality of parallax videos corresponding to an input video signal;
a viewing zone boundary processor configured to process pixels in a viewing zone boundary of a plurality of sharpened parallax videos; and
a viewing zone expansion processor configured to expand a viewing zone in a plurality of processed parallax video.

2. The video signal processing apparatus of claim 1, wherein the video sharpening processor is configured to sharpen the first plurality of parallax videos using a luminance profile of a display panel, the display panel being configured to display the input video signal.

3. The video signal processing apparatus of claim 1, further comprising a warning message display configured to superimpose a warning message on the plurality of sharpened parallax videos, the warning message being indicative of a viewing position being in a pseudoscopy region.

4. The video signal processing apparatus of claim 2, wherein the sharpening processor comprises:
a memory configured to store sharpening coefficients associated with the luminance profile of the display panel; and
an arithmetic processor configured to arithmetically operate sharpening based on the sharpening coefficients and the first plurality of parallax videos.

5. The video signal processing apparatus of claim 1, further comprising:
a depth information estimator configured to estimate depth information of an input video using the input video signal; and
a first parallax video generator configured to generate the first plurality of parallax videos from the input video signal using the depth information.

6. The video signal processing apparatus of claim 5, further comprising:
a second parallax video generator configured to generate a second plurality of parallax videos from graphics based on the graphics, depth information of the graphics, and blending information; and
a blender configured to blend the first plurality of parallax videos and the second plurality of parallax videos into a plurality of blended parallax videos using the blending information, wherein
the video sharpening processor is configured to receive the plurality of blended parallax videos.

7. The video signal processing apparatus of claim 5, further comprising:
a second parallax video generator configured to generate a second plurality of parallax videos of graphics based on the graphics, depth information of the graphics, and blending information; and
a blender configured to blend the plurality of sharpened parallax videos and the second plurality of parallax videos into a plurality of blended parallax videos using the blend information, wherein
the viewing zone boundary processor is configured to receive the plurality of blended parallax videos.

8. A video signal processing method comprising:
sharpening a first plurality of parallax videos corresponding to an input video signal;
processing pixels in a viewing zone boundary of a plurality of sharpened parallax videos; and
expanding a viewing zone in a plurality of processed parallax videos.

9. The video signal processing method of claim 8, wherein the sharpening the first plurality of parallax videos uses a luminance profile of a display panel being configured to display the input video signal.

10. The video signal processing method of claim 8, further comprising superimposing a warning message on the plurality of sharpened parallax videos, the warning message being indicative of a viewing position being in a pseudoscopy region.

11. The video signal processing method of claim 9, wherein the sharpening the first plurality of parallax videos comprises:
storing sharpening coefficients associated with the luminance profile of the display panel; and
arithmetically operating sharpening based on the sharpening coefficients and the first plurality of parallax videos.

12. The video signal processing method of claim 8, further comprising:
estimating depth information of an input video using the input video signal; and
generating the first plurality of parallax video from the input video signal.

13. A video display apparatus comprising:
a video sharpening processor configured to sharpen a first plurality of parallax videos corresponding to an input video signal;
a viewing zone boundary processor configured to process pixels in a viewing zone boundary of a plurality of sharpened parallax videos;
a viewing zone expansion processor configured to expand a viewing zone in a plurality of processed parallax videos; and
a display panel configured to display a plurality of expanded parallax videos.

14. The video display apparatus of claim 13, wherein the video sharpening processor is configured to sharpen the first plurality of parallax videos using a luminance profile of the display panel.
